(19) United States
(12) Patent Application Publication
(10) Pub. No.: US 2025/0080949 A1
(43) Pub. Date: Mar. 6, 2025

(54) GROUPCAST BASED SIDELINK POSITIONING

(71) Applicant: TELEFONAKTIEBOLAGET LM ERICSSON (PUBL), Stockholm (SE)

(72) Inventors: RITESH SHREEVASTAV, UPPLANDS VÄSBY (SE); ANTONINO ORSINO, KIRKKONUMMI (FI); HENRIK RYDÉN, STOCKHOLM (SE); SINH NGUYEN, GÖTEBORG (SE); PETER HAMMARBERG, MÖLNDAL (SE)

(21) Appl. No.: 18/705,617

(22) PCT Filed: Oct. 28, 2022
(86) PCT No.: PCT/IB2022/060408

§ 371 Date: Apr. 29, 2024

Related U.S. Application Data
(60) Provisional application No. 63/273,502, filed on Oct. 29, 2021.

(51) Int. Cl. H04W 4/029; G01S 1/04; H04W 4/40

(52) U.S. Cl. CPC H04W 4/029; G01S 1/0428; H04W 4/40

(57) ABSTRACT

Systems and methods for configuring groupings of wireless devices and performing positioning and/or ranging between the grouped devices. Several wireless devices can be grouped together according to location, capabilities and/or measurements. A master node can be assigned to perform initiate a sidelink ranging procedure for the group. The master node can transmit ranging request(s) and receive ranging response(s) to calculate a range for one or more wireless devices in the group.

### CROSS REFERENCE TO RELATED APPLICATIONS

This application claims the benefit of U.S. Provisional Application No. 63/273,502 filed on Oct. 29, 2021, the entire contents of which are hereby incorporated by reference.

### TECHNICAL FIELD

The present disclosure generally relates to wireless communications and wireless communication networks.

### INTRODUCTION

Standardization bodies such as Third Generation Partnership Project (3GPP) are studying potential solutions for efficient operation of wireless communication in new radio (NR) networks. The next generation mobile wireless communication system 5G/NR will support a diverse set of use cases and a diverse set of deployment scenarios. The later includes deployment at both low frequencies (e.g. 100s of MHz), similar to LTE today, and very high frequencies (e.g. mm waves in the tens of GHz). Besides the typical mobile broadband use case, NR is being developed to also support machine type communication (MTC), ultra-low latency critical communications (URLCC), side-link device-to-device (D2D) and other use cases.

Positioning and location services have been topics in LTE standardization since 3GPP Release 9. An objective was to fulfill regulatory requirements for emergency call positioning but other use case like positioning for Industrial Internet of Things (I-IoT) are also considered. Positioning in NR is supported by the example architecture shown in FIG. 1. LMF 108A represents the location management function entity in NR. There are also interactions between the LMF 108A and the gNodeB 110 via the NRPPa protocol. The interactions between the gNodeB 110 and the device (UE) 112 are supported via the Radio Resource Control (RRC) protocol, while the location node 108A interfaces with the UE 112 via the LTE positioning protocol (LPP). LPP is common to both NR and LTE technologies. Other network nodes, such as Access and Mobility Management Function (AMF) 108B and evolved Serving Mobile Location Center (e-SMLC) 108C, may be involved in positioning support.

It will be appreciated that while FIG. 1 shows gNB 110B and ng-eNB 110A, both may not always be present. It is noted that when both the gNB 110B and ng-eNB 110A are present, the NG-C interface is generally only present for one of them.

In the legacy LTE standards, the following techniques are supported:
Enhanced Cell ID. Essentially cell ID information to associate the device to the serving area of a serving cell, and then additional information to determine a finer granularity position.
Assisted Global Navigation Satellite System (GNSS). GNSS information retrieved by the device, supported by assistance information provided to the device from E-SMLC
OTDOA (Observed Time Difference of Arrival). The device estimates the time difference of reference signals from different base stations and sends to the E-SMLC for multilateration.
UTDOA (Uplink TDOA). The device is requested to transmit a specific waveform that is detected by multiple location measurement units (e.g. an eNB) at known positions. These measurements are forwarded to E-SMLC for multilateration.
Sensor methods such as biometric pressure sensor which provides vertical position of the device and Inertial Motion Unit (IMU) which provides displacement.

NR positioning since Release 16, based on the 3GPP NR radio-technology, has provided added value in terms of enhanced location capabilities. The operation in low and high frequency bands (i.e. below and above 6 GHz) and utilization of massive antenna arrays provide additional degrees of freedom to substantially improve the positioning accuracy. The possibility to use wide signal bandwidth in low and especially in high bands brings new performance bounds for user location for well-known positioning techniques based on OTDOA and UTDOA, Cell-ID or E-Cell-ID etc., utilizing timing measurements to locate a UE.

NR supports the following radio access technology (RAT)-dependent positioning methods.

DL-TDOA: The DL-TDOA positioning method makes use of the DL RSTD (and optionally DL PRS RSRP) of downlink signals received from multiple transmission points (TPs), at the UE. The UE measures the DL RSTD (and optionally DL PRS RSRP) of the received signals using assistance data received from the positioning server, and the resulting measurements are used along with other configuration information to locate the UE in relation to the neighbouring TPs.

Multi-RTT: The Multi-RTT positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.

UL-TDOA: The UL-TDOA positioning method makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

DL-AoD: The DL-AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighbouring TPs.

UL-AoA: The UL-AoA positioning method makes use of the measured azimuth and zenith of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.

NR-ECID: NR Enhanced Cell ID (NR E-CID) positioning refers to techniques which use additional UE measurements and/or NR radio resource and other measurements to improve the UE location estimate.

The positioning modes can be categorized as UE-assisted, UE-based, or standalone.

UE-Assisted: The UE performs measurements with or without assistance from the network and sends these measurements to the E-SMLC where the position calculation may take place.

UE-Based: The UE performs measurements and calculates its own position with assistance from the network.

Standalone: The UE performs measurements and calculates its own without network assistance.

### Sidelink Transmissions in NR

3GPP specified the LTE D2D (device-to-device) technology, also known as ProSe (Proximity Services) in the Release 12 and 13 of LTE. Later in Release 14 and 15, LTE Vehicle-to-everything communication (V2X) related enhancements targeting the specific characteristics of vehicular communications were specified. 3GPP started a new work item (WI) in August 2018 within the scope of Rel. 16 to develop a new radio (NR) version of V2X communications. The NR V2X mainly targets advanced V2X services, which can be categorized into four use case groups: vehicles platooning, extended sensors, advanced driving and remote driving. The advanced V2X services would require enhancements of the NR system and a new NR sidelink framework could help to meet the stringent requirements in terms of latency and reliability. NR V2X system also expects to have higher system capacity and better coverage and to allow for an easy extension to support the future development of further advanced V2X services and other services.

Given the targeted services by NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service there are certain messages that are only of interest of the members of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast and unicast transmissions. Furthermore, NR sidelink is designed in such a way that its operation is possible with and without network coverage and with varying degrees of interaction between the UEs and the network, including support for standalone, network-less operation.

In 3GPP Release 17, National Security and Public Safety (NSPS) is considered to be one use case which can benefit from the already developed NR sidelink features in Release 16. Therefore, it is likely that 3GPP will specify enhancements related to the NSPS use case taking NR Release 16 sidelink as a baseline. In some scenarios, NSPS services need to operate with partial or without network coverage, such as indoor firefighting, forest firefighting, earthquake rescue, sea rescue, etc. where the infrastructure is (partially) destroyed or not available. Therefore, coverage extension is a crucial enabler for NSPS, for both NSPS services communicated between UE and the cellular network and that communicated between UEs over sidelink. In Release 17, a SID on NR sidelink relay (RP-193253) was launched which aims to further explore coverage extension for sidelink-based communication, including both UE-to-network relay for cellular coverage extension and UE-to-UE relay for sidelink coverage extension.

FIG. 2 illustrates three different sidelink communication scenarios: in-coverage, out-of-coverage, and partial coverage.

UEs that are “in-coverage” of a gNB rely on configuration (through RRC and/or SIB) from the network. UEs that are “out-of-coverage” of a gNB can rely on a (pre-)configuration available in the SIM of the device. Pre-configuration can be (semi-)static and updates can be possible (e.g. when that UE is in coverage).

Sidelink communication can be performed in three different transmission modes: unicast, broadcast and groupcast. Further details are provided below from 3GPP TR 38.836 V17.0.0.

### V2X Communication Over PC5 Reference Point

### General

For V2X communication, two types of PC5 reference points exist: the LTE based PC5 reference point as defined in TS 23.285 v16.4.0 [6], and the NR based PC5 reference point as defined in clause 4.2.3. A UE may use either type of PC5 or both for V2X communication depending on the services the UE supports. The V2X communication over PC5 reference point supports roaming and inter-PLMN operations. V2X communication over PC5 reference point is supported when UE is “served by NR or E-UTRA” or when the UE is “not served by NR or E-UTRA”.

A UE is authorized to transmit and receive V2X messages when it has valid authorization and configuration as specified in clause 5.1.2.

The V2X communication over PC5 reference point has the following characteristics:
V2X communication over LTE based PC5 reference point is connectionless, i.e. broadcast mode at Access Stratum (AS) layer, and there is no signalling over PC5 for connection establishment.
V2X communication over NR based PC5 reference point supports broadcast mode, groupcast mode, and unicast mode at AS layer. If V2X application layer of the UE indicates the mode of communication to V2X layer, the V2X layer shall set the mode of communication based on the request of the V2X application layer; otherwise, the V2X layer sets the mode of communication based on the mapping information for a V2X service type defined in clause 5.1.2.1. The V2X layer indicates the mode of communication for the V2X service type to the AS layer. Signalling over control plane over PC5 reference point for unicast mode communication management is supported.
V2X services communication support between UEs over PC5 user plane.
Both IP based and non-IP based V2X services communication are supported over PC5 reference point.
For IP based V2X services communication, only IPv6 is used. IPv4 is not supported.
V2X messages are exchanged between UEs over PC5 user plane.
Both IP based and non-IP based V2X messages are supported over PC5 reference point.
For IP based V2X messages, only IPv6 is used. IPv4 is not supported.

The identifiers used in the V2X communication over PC5 reference point are described in clause 5.6.1 [3GPP TS 23.287 V17.0.0]. UE decides on the type of PC5 reference point and for LTE PC5 Tx Profile also to use for the transmission of a particular packet based on the configuration described in clause 5.1.2. When the LTE based PC5 reference point is selected, the QoS handling corresponding procedures are defined in 3GPP TS 23.285. When NR based PC5 reference point is selected, the QoS handling and procedures are defined in clauses 5.4.1 and 6.3.

If the UE has an ongoing emergency session via IMS, the ongoing emergency session via IMS shall be prioritized over V2X communication over PC5 reference point.

NOTE: The emergency session via IMS setup is based on appropriate regional/national regulatory requirements and operator policies as defined in 3GPP TS 23.501.

The security for V2X communication over PC5 reference point is provided with mechanisms defined in 3GPP TS 33.536. For broadcast and groupcast mode communication, security is supported in the V2X application layer schemes developed in other SDOs.

The pedestrian UEs may use the PC5 DRX mechanism to perform V2X communication over PC5 reference point with power efficiency as specified in clause 5.9.

### Broadcast Mode Communication Over PC5 Reference Point

Broadcast mode of communication is supported over both LTE based PC5 reference point and NR based PC5 reference point. Therefore, when broadcast mode is selected for transmission over PC5 reference point, PC5 RAT selection needs to be performed based on configuration described in clause 5.1.2. Based on configuration described in clause 5.1.2 and the availability of the corresponding PC5 RAT(s) for the specific V2X service type, the V2X layer in the UE determines PC5 RAT(s) and passes the packet to the applicable PC5 AS (Access Stratum) layer(s) with the appropriate PC5 QoS parameters as defined in clause 5.4.1.1.1

For LTE based PC5 reference point, broadcast mode is the only supported communication mode, and the operation details are defined in 3GPP TS 23.285.

For NR based PC5 reference point, the broadcast mode also supports enhanced QoS handling as defined in clause 5.4.1.

### Groupcast Mode Communication Over PC5 Reference Point

Groupcast mode communication is only supported over NR based PC5 reference point and applies to all types of groups, i.e. Application Layer connection-less group and Application Layer managed group.

For Application Layer managed group, the following applies:
If the V2X application layer provides a group size and a member ID, the V2X layer passes them to the AS layer for groupcast control, as defined in 3GPP TS 38.300.

NOTE: It is assumed that the V2X application layer provides accurate and up-to-date information on the group size and the member ID.

QoS handling for groupcast mode communication is defined in clause 5.4.1.

### Unicast Mode Communication Over PC5 Reference Point

Unicast mode of communication is only supported over NR based PC5 reference point. FIG. 3 illustrates an example of PC5 unicast links.

The following principles apply when the V2X communication is carried over PC5 unicast link:
A PC5 unicast link between two UEs allows V2X communication between one or more pairs of peer V2X services in these UEs. All V2X services in the UE using the same PC5 unicast link use the same Application Layer ID.

NOTE 1: An Application Layer ID can change in time as described in clauses 5.6.1.1 and 6.3.3.2, due to privacy. This does not cause a re-establishment of a PC5 unicast link. The UE triggers a Link Identifier Update procedure as specified in clause 6.3.3.2.
One PC5 unicast link supports one or more V2X service types) if these V2X service types are at least associated with the pair of peer Application Layer IDs for this PC5 unicast link. For example, as illustrated in FIG. 5.2.1.4-1, UE A and UE B have two PC5 unicast links, one between peer Application Layer ID 1/UE A and Application Layer ID 2/UE B and one between peer Application Layer ID 3/UE A and Application Layer ID 4/UE B.

NOTE 2: A source UE is not required to know whether different target Application Layer IDs over different PC5 unicast links belong to the same target UE.
A PC5 unicast link supports V2X communication using a single network layer protocol e.g. IP or non-TP.
A PC5 unicast link supports per-flow QoS model as specified in clause 5.4.1.
If multiple V2X service types use a PC5 unicast link, one PC5 QoS Flow identified by PFI may be associated with more than one V2X service types.

When the Application layer in the UE initiates data transfer for a V2X service type which requires unicast mode of communication over PC5 reference point:
the UE shall reuse an existing PC5 unicast link if the pair of peer Application Layer IDs and the network layer protocol of this PC5 unicast link are identical to those required by the application layer in the UE for this V2X service, and modify the existing PC5 unicast link to add this V2X service type as specified in clause 6.3.3.4; otherwise
the UE shall trigger the establishment of a new PC5 unicast link as specified in clause 6.3.3.1.

After successful PC5 unicast link establishment, UE A and UE B use the same pair of Layer-2 IDs for subsequent PC5-S signalling message exchange and V2X service data transmission as specified in clause 5.6.1.4. The V2X layer of the transmitting UE indicates to the AS layer whether a transmission is for a PC5-S signalling message (i.e. Direct Communication Request/Accept, Link Identifier Update Request/Response/Ack, Disconnect Request/Response, Link Modification Request/Accept, Keep-alive/Ack) or V2X service data.

For every PC5 unicast link, a UE self-assigns a distinct PC5 Link Identifier that uniquely identifies the PC5 unicast link in the UE for the lifetime of the PC5 unicast link. Each PC5 unicast link is associated with a Unicast Link Profile which includes:
Application Layer ID and Layer-2 ID of UE A; and
Application Layer ID and Layer-2 ID of UE B; and
network layer protocol used on the PC5 unicast link; and
the information about PC5 QoS Flow(s). For each PC5 QoS Flow, the PC5 QoS Context and the PC5 QoS Rule(s) as defined in clause 5.4.1.1.3.

For privacy reason, the Application Layer IDs and Layer-2 IDs may change as described in clauses 5.6.1.1 and 6.3.3.2 during the lifetime of the PC5 unicast link and, if so, shall be updated in the Unicast Link Profile accordingly. The UE uses PC5 Link Identifier to indicate the PC5 unicast link to V2X Application layer, therefore V2X Application layer identifies the corresponding PC5 unicast link even if there are more than one unicast link associated with one V2X service type (e.g. the UE establishes multiple unicast links with multiple UEs for a same V2X service type).

The Unicast Link Profile shall be updated accordingly after a Layer-2 link modification for an established PC5 unicast link as specified in clause 6.3.3.4 or Layer-2 link identifier update as specified in clause 6.3.3.2.

Upon receiving an indication from the AS layer that the PC5-RRC connection was released due to RLF, the V2X layer in the UE locally releases the PC5 unicast link associated with this PC5-RRC connection. The AS layer uses PC5 Link Identifier to indicate to the V2X layer the PC5 unicast link whose PC5-RRC connection was released.

When the PC5 unicast link has been released as specified in clause 6.3.3.3, the V2X layer of each UE for the PC5 unicast link informs the AS layer that the PC5 unicast link has been released. The V2X layer uses PC5 Link Identifier to indicate the released unicast link.

### Identifiers for V2X Communication Over PC5 Reference Point

Each UE has one or more Layer-2 IDs for V2X communication over PC5 reference point, consisting of:
Source Layer-2 ID(s); and
Destination Layer-2 ID(s).

Source and destination Layer-2 IDs are included in layer-2 frames sent on the layer-2 link of the PC5 reference point identifying the layer-2 source and destination of these frames. Source Layer-2 IDs are always self-assigned by the UE originating the corresponding layer-2 frames.

The selection of the source and destination Layer-2 ID(s) by a UE depends on the communication mode of V2X communication over PC5 reference point for this layer-2 link, as described in clauses 5.6.1.2, 5.6.1.3, and 5.6.1.4. The source Layer-2 IDs may differ between different communication modes.

When IP-based V2X communication is supported for broadcast and groupcast modes of V2X communication over PC5 reference point, the source IP address is allocated as described in clause 5.2.1.5.

If the UE has an active V2X application that requires privacy support in the current Geographical Area, as identified by configuration described in clause 5.1.2.1, in order to ensure that a source UE (e.g. vehicle) cannot be tracked or identified by any other UEs (e.g. vehicles) beyond a certain short time-period required by the application, the source Layer-2 ID shall be changed over time and shall be randomized. For IP-based V2X communication over PC5 reference point, the source IP address shall also be changed over time and shall be randomized. The change of the identifiers of a source UE must be synchronized across layers used for PC5, (e.g. when the Application Layer ID changes, the source Layer-2 ID and the source IP address need to be changed).

### Identifiers for Broadcast Mode V2X Communication Over PC5 Reference Point

For broadcast mode of V2X communication over PC5 reference point, the UE is configured with the destination Layer-2 ID(s) to be used for V2X services. The destination Layer-2 ID for a V2X communication is selected based on the configuration as described in clause 5.1.2.1.

The UE self-selects a source Layer-2 ID. The UE may use different source Layer-2 IDs for different types of PC5 reference points, i.e. LTE based PC5 and NR based PC5.

### Identifiers for Groupcast Mode V2X Communication Over PC5 Reference Point

For groupcast mode of V2X communication over PC5 reference point, the V2X application layer may provide group identifier information. When the group identifier information is provided by the V2X application layer, the UE converts the provided group identifier into a destination Layer-2 ID. When the group identifier information is not provided by the V2X application layer, the UE determines the destination Layer-2 ID based on configuration of the mapping between V2X service type and Layer-2 ID, as specified in clause 5.1.2.1.

NOTE: The mechanism for converting the V2X application layer provided group identifier to the destination Layer-2 ID is defined in Stage 3.

The UE self-selects a source Layer-2 ID.

### Identifiers for Unicast Mode V2X Communication Over PC5 Reference Point

For unicast mode of V2X communication over PC5 reference point, the destination Layer-2 ID used depends on the communication peer. The Layer-2 ID of the communication peer, identified by the Application Layer ID, may be discovered during the establishment of the PC5 unicast link, or known to the UE via prior V2X communications, e.g. existing or prior unicast link to the same Application Layer ID, or obtained from application layer service announcements. The initial signalling for the establishment of the PC5 unicast link may use the known Layer-2 ID of the communication peer, or a default destination Layer-2 ID associated with the V2X service type configured for PC5 unicast link establishment, as specified in clause 5.1.2.1. During the PC5 unicast link establishment procedure, Layer-2 IDs are exchanged, and should be used for future communication between the two UEs, as specified in clause 6.3.3.1.

The Application Layer ID is associated with one or more V2X applications within the UE. If UE has more than one Application Layer IDs, each Application Layer ID of the same UE may be seen as different UE's Application Layer ID from the peer UE's perspective.

The UE maintains a mapping between the Application Layer IDs and the source Layer-2 IDs used for the PC5 unicast links, as the V2X application layer does not use the Layer-2 IDs. This allows the change of source Layer-2 ID without interrupting the V2X applications.

When Application Layer IDs change, the source Layer-2 ID(s) of the PC5 unicast link(s) shall be changed if the link(s) was used for V2X communication with the changed Application Layer IDs.

Based on privacy configuration as specified in clause 5.1.2.1, the update of the new identifiers of a source UE to the peer UE for the established unicast link may cause the peer UE to change its Layer-2 ID and optionally IP address/prefix if IP communication is used as defined in clause 6.3.3.2.

A UE may establish multiple PC5 unicast links with a peer UE and use the same or different source Layer-2 IDs for these PC5 unicast links.

The term “Ranging” can be used to refer to the determination of the distance between two UEs or more UEs and/or the direction and/or relative positioning of one UE (i.e. Target UE) from another UE (i.e. Reference UE) via the PC5 interface.

### SUMMARY

It is an object of the present disclosure to obviate or mitigate at least one disadvantage of the prior art.

There are provided systems and methods for configuring and performing positioning between grouped wireless devices.

In a first aspect there is provided a method performed by a first wireless device. The first wireless device can comprise a radio interface and processing circuitry and be configured to determine to initiate a sidelink group ranging procedure. The first wireless device transmits a ranging request to one or more second wireless devices and receives a ranging response, including timing information, from at least one of the second wireless devices. The first wireless device calculates a range for the at least one second wireless device in accordance with the timing information.

In some embodiments, the first wireless device determines to initiate a sidelink group ranging procedure in response to receiving a request for ranging measurements. The request for ranging measurements can be received from one of: a network node and/or one of the second wireless devices.

In some embodiments, group membership information is received from a network node, wherein the group membership information identifies the one or more second wireless devices. The sidelink group ranging procedure can be associated with the group membership information.

In some embodiments, the first wireless device receives an indication that it is a master node for the sidelink group ranging procedure. The master node can have a capability to perform at least one of positioning and ranging calculations for the second wireless devices.

In some embodiments, the ranging request is transmitted via one of: unicast, multicast, and/or groupcast signaling.

In some embodiments, the ranging request includes one of: a positioning reference signal (PRS), an uplink sounding reference signal (UL-SRS) for positioning, and a Channel Status Information Reference Signal (CSI-RS).

In some embodiments, the ranging response includes a MAC control element (CE) message. The MAC CE can include the timing information.

In some embodiments, the timing information includes at least one time measurement based on at least one of: reception of the ranging request and/or transmission of the ranging response by the at least one second wireless device.

In some embodiments, the first wireless device can further determine a position of the at least one second wireless device in accordance with the timing information. The determined position of the at least one second wireless device can be transmitted to a network node.

In some embodiments, the calculated range for the at least one second wireless device can be transmitted to a network node.

In some embodiments, the first wireless device can exchange (e.g. transmit and received) with a network node, capability information associated with the sidelink group ranging procedure.

In another aspect there is provided a method performed by a network node. The network node can comprise a radio interface and processing circuitry and be configured to transmit, to a first wireless device, a request for ranging measurements for one or more second wireless devices; and receive, from the first wireless device, at least one ranging measurement for the one or more second wireless devices.

In some embodiments, the network node can determine one or more groups of wireless devices in accordance with received capability information and/or received ranging measurements. In some embodiments, the network node can transmit group membership information to at least one of the first and second wireless devices.

In some embodiments, the request for ranging measurements is a request to initiate a sidelink group ranging procedure.

In some embodiments, the network node can transmit an indication that the first wireless device is a master node for the sidelink group ranging procedure. The master node can have a capability to perform at least one of positioning and ranging calculations for the second wireless devices.

In some embodiments, the received ranging measurement can include at least one calculated range for at least one of the second wireless devices. In other embodiments, the received ranging measurement can include at least one time measurement based on reception of the ranging request and/or transmission of the ranging response by the at least one second wireless device.

In some embodiments, the network node can further receive, from the first wireless device, a position of at least one of the second wireless devices.

The various aspects and embodiments described herein can be combined alternatively, optionally and/or in addition to one another.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures, wherein:

FIG. 1 illustrates an example of NR positioning architecture;

FIG. 2 illustrates an example of sidelink communication scenarios;

FIG. 3 illustrates an example of PC5 unicast links;

FIG. 4 is an example communication system;

FIG. 5 is a flow chart illustrating a method for performing grouping based on ranging;

FIG. 6 is a flow chart illustrating a method for performing grouping;

FIG. 7 is a flow chart illustrating a method for performing ranging estimation;

FIG. 8 is an example of UE grouping based on velocity;

FIG. 9 is an example MAC control element;

FIG. 10 is an example of blockages in a network;

FIG. 11 is a block diagram of an example wireless device;

FIG. 12 is a block diagram of an example network node;

FIG. 13 is a block diagram of an example host;

FIG. 14 is a block diagram illustrating an example virtualization environment; and

FIG. 15 is a communication diagram of a host communicating via a network node with a UE.

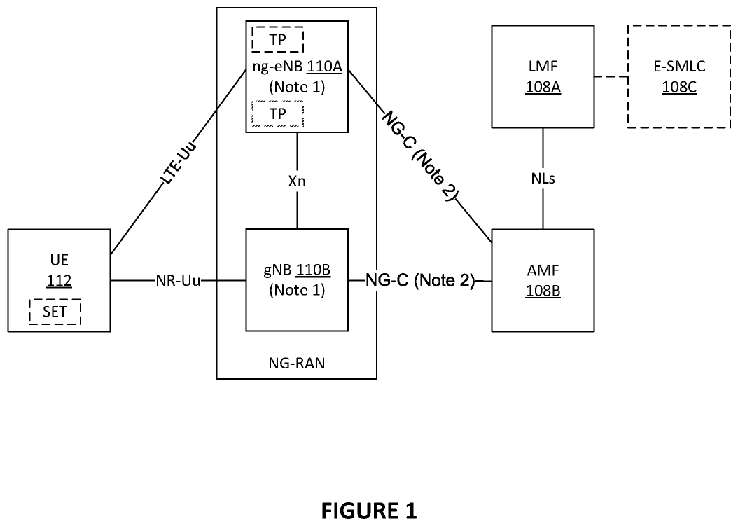

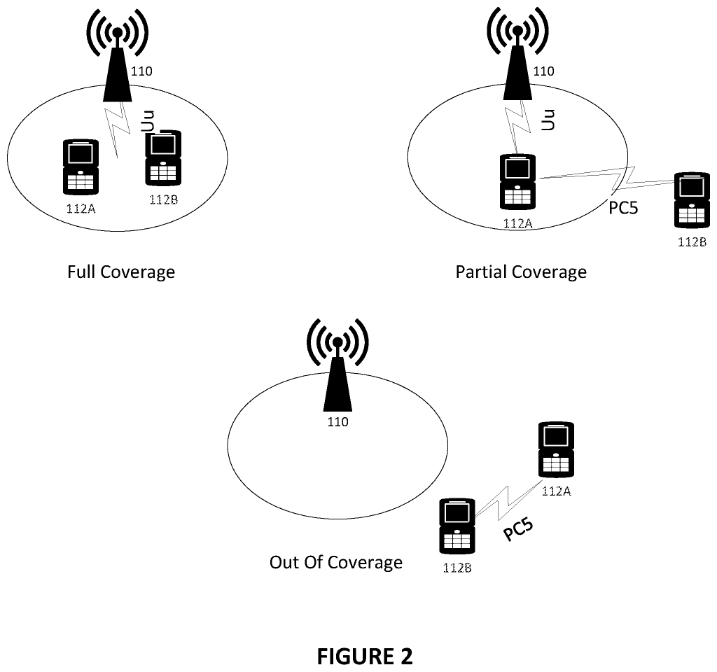

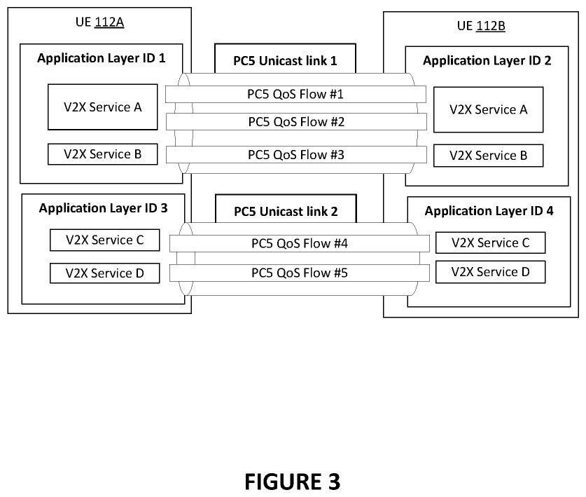

### DETAILED DESCRIPTION

The embodiments set forth below represent information to enable those skilled in the art to practice the embodiments. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

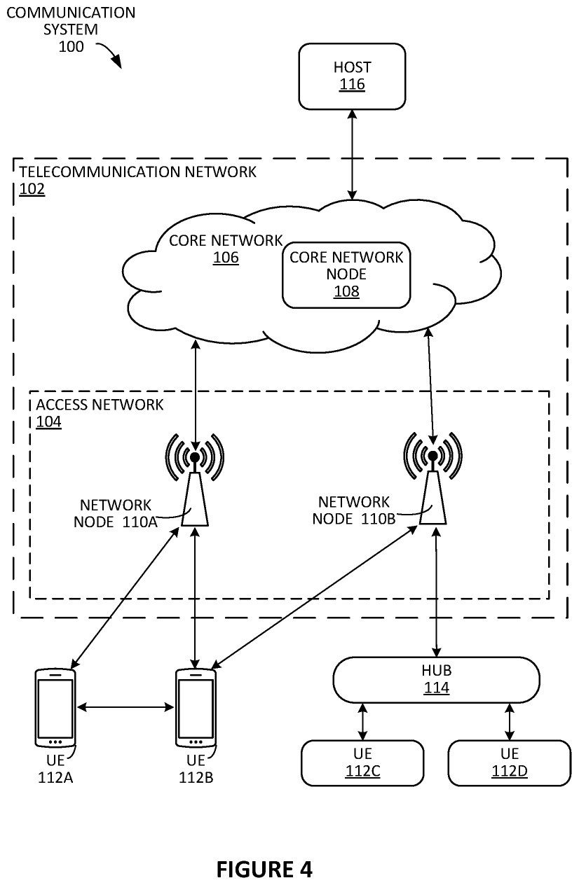

FIG. 4 illustrates an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110A and 110B (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112A, 112B, 112C, and 112D (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one or more core network nodes (e.g. core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Location Management Function (LMF), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g. UE 112C and/or 112D) and network nodes (e.g. network node 110B). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110B. The hub 114 may also allow for a different communication scheme and/or schedule between the hub 114 and UEs (e.g. UE 112C and/or 112D), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110B. In other embodiments, the hub 114 may be a non-dedicated hub—that is, a device which is capable of operating to route communications between the UEs and network node 110B, but which is additionally capable of operating as a communication start and/or end point for certain data channels.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”. However, particularly with respect to 5G/NR concepts, beams may be used instead of cells and, as such, it is important to note that the concepts described herein are equally applicable to both cells and beams.

Returning to the discussion of positioning, some use cases can involve group-based location estimations such as vehicle platooning or drones. How such groups can be formed and how positioning information can be exchanged between the network and one or more groups of UEs are not yet known. The issues of how signaling can be done in such group-based UE such that UEs learn which group they belong to and/or who are their peers, what needs to be signaled amongst a group of UEs and further, how it can be signaled to compute positionings remain to be determined.

By grouping UEs it is possible that, if one UE location is known, the position of the other UE(s) in the same group can be estimated. Only one UE within a group may need to perform absolute localization, potentially leading to battery savings for the other UEs in the group. By selecting a master node for the group, more efficient coordination can be achieved.

Some embodiments herein include grouping of devices and/or selection of a master node responsible for connection with network and for initiating procedures within the group. Some embodiments include triggering of ranging between master node and group members using groupcast and/or other signaling. Some embodiments include the protocol aspects of groupcast-based ranging.

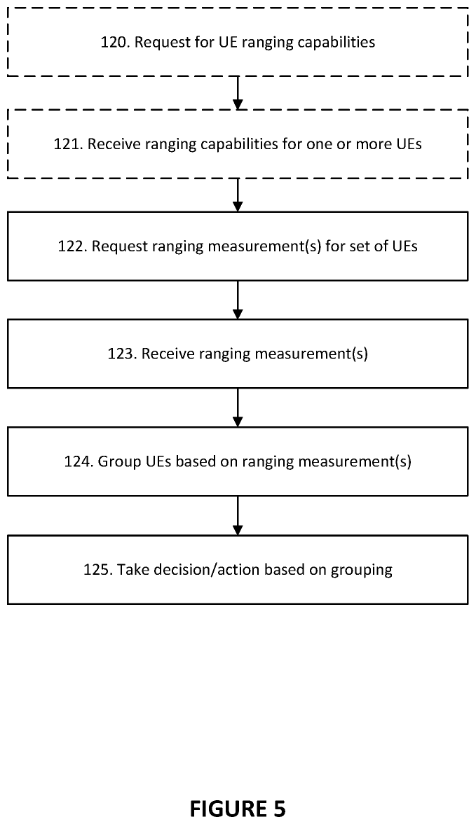

FIG. 5 is a flow chart illustrating an example method for grouping based on ranging. The method can be performed in a network node, such as gNB 110 and/or a core network node 108 (e.g. location server) as described herein. The method can include:

Step 120: Optionally, the network node can transmit a request for UE ranging capabilities.

Step 121: Optionally, the network node can receive ranging capabilities associated with one or more UEs.

Step 122: The network node can transmit a request for ranging measurement(s) for one or more UEs. Optionally, this can be based on the received ranging capabilities.

Step 123: The network node can receive one or ranging measurements from the UE(s).

Step 124: The network node can group one or more UEs in accordance with the received ranging measurements.

Step 125: The network node can take a decision and/or action based on the determined grouping of UEs.

It will be appreciated that one or more of the above steps can be performed simultaneously and/or in a different order. Also, steps illustrated in dashed lines are optional and can be omitted in some embodiments.

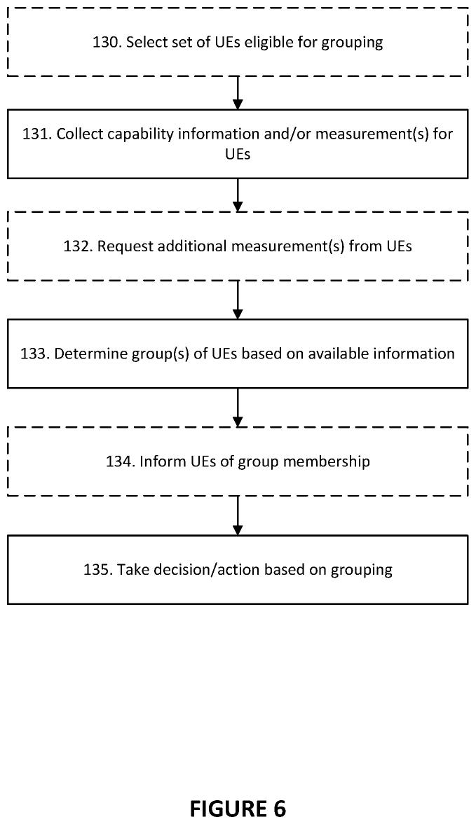

FIG. 6 is a flow chart illustrating an example method for grouping devices. The method can be performed in a network node, such as gNB 110 and/or a core network node 108 (e.g. location server) as described herein. The method can include:

Step 130: Optionally, the network node can select a set of UEs eligible for grouping.

Step 131: The network node can receive and collect measurements and/or capability information from the eligible UEs.

Step 132: Optionally, the network node can transmit a request for additional measurements from the UEs (e.g. local sensor data, radio measurements, etc.).

Step 133: The network node can determine one or more groups of UEs in accordance with the received information.

Step 134: Optionally, the network node can transmit a message to the UE(s) informing them of the determined group membership.

Step 135: The network node can take a decision and/action based on the determined grouping of UEs.

It will be appreciated that one or more of the above steps can be performed simultaneously and/or in a different order. Also, steps illustrated in dashed lines are optional and can be omitted in some embodiments.

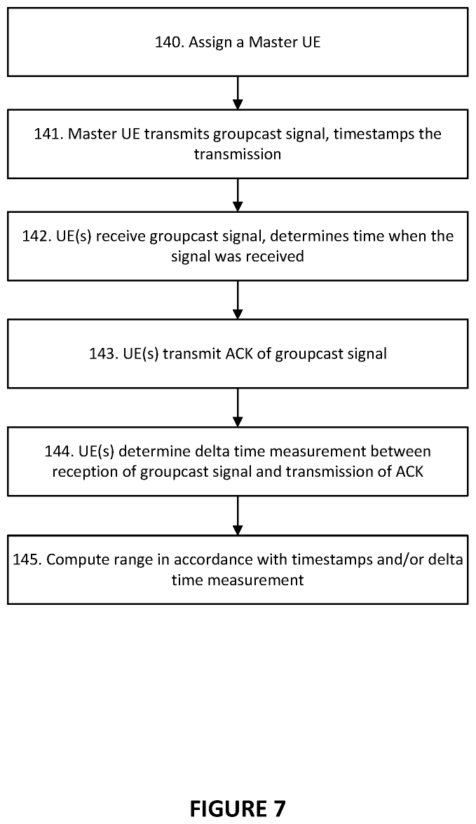

FIG. 7 is a flow chart illustrating an example method for ranging estimations. The method can be performed in a wireless device, such as a UE 112, and a network node, such as gNB 110 and/or a core network node 108 (e.g. location server) as described herein. The method can include:

Step 140: A master UE can be assigned by a network node and/or one or more UEs. The master node can have a capability to perform at least one of positioning and ranging calculations for other UEs. In some embodiments, the selection of a master UE can be prioritized based on network coverage. For example, some UEs can be determined to be in coverage, partial coverage or out of coverage.

Step 141: The master UE can transmit a ranging request message (e.g. groupcast signal) to one or more UEs. The transmission can be timestamped.

Step 142: The UEs involved in receiving the ranging request (groupcast) can compute/determine the time when the signal is received.

Step 143: Each UE can transmit an acknowledgement or indication, indicating when the ranging request (groupcast) was received. The acknowledgement can be transmitted as a ranging response to, and received by, the master UE.

Step 144: Each UE can calculate a delta time measurement of the time between receiving the ranging request (groupcast signal) and sending the ranging response (acknowledgement). The delta time measurement can be encapsulated in a message such as a MAC control element. The MAC control element can be sent to, and received by, the master UE. In some embodiments, the timing information can be included in the ranging response. In other embodiments, the timing information can be included in another message.

Step 145: The master UE can determine and record a timestamp for the reception of the ranging response (acknowledgement) from each UE. A range can be computed in accordance with the transmission timestamp, the delta time measurement and/or the reception timestamp. Optionally, the information can be shared with the network for positioning and/or range calculations. Optionally, the master UE can also determine a position for each UE.

It will be appreciated that in some embodiments, the wireless device (UEs, master UE) can communicate (e.g. transmit/receive messages) directly with a network node such as location server 108. In other embodiments, messages and signals between the entities may be communicated via other nodes, such as radio access node (e.g. gNB, eNB) 110.

It will be appreciated that one or more of the above steps can be performed simultaneously and/or in a different order. Also, steps illustrated in dashed lines are optional and can be omitted in some embodiments.

### Grouping of UEs

By the grouping of UEs which share certain attributes or are located in the vicinity of each other, gains in the administration or quality of some services can be achieved. One such service is positioning where relative positioning between devices obtained through ranging can be combined with absolute positioning (e.g. GNSS or RAT-based) to achieve more reliable positioning estimates.

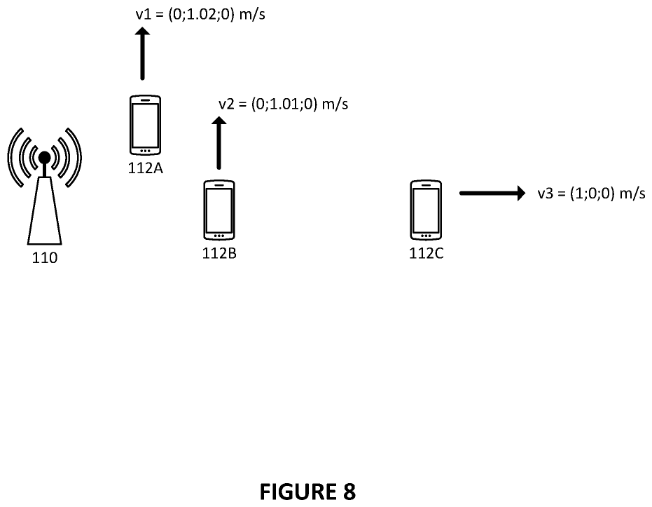

In one embodiment, the network can group the UEs based on a threshold of accelerometer, light sensor, gyroscope data and/or ranging estimations. One example is illustrated in FIG. 8, where the network receives velocity sensor data for three UEs. The network can then identify the grouping for example by calculating the Euclidian distance of the velocity vectors (v1, v2, v3), and comparing with a threshold.

The grouping may be performed for different purposes and hence there may be different criteria in which the grouping is determined. The grouping criteria can comprise one or more of the following non-limiting examples:
Accelerometer measurement: showing that all UEs in the group are accelerating in a similar way.
Gyro measurements: showing that the UEs in the group are rotating in a similar manner.
Compass/magnetometer measurements: showing that the UEs in the group are oriented in a similar or correlated manner.
Light sensor measurement: showing that all UEs in the group are experiencing the similar indoor, semi-indoor, outdoor environment.
Barometric measurement: showing that all UEs in the group are on the same height for example they are on the same floor.
Similar reference point for displacement measurement: showing that all UEs in the group are in the vicinity of the same reference point.
A combination of the above measurements: showing that all UEs in the group are facing the same scenario (e.g. sitting in the same train, the same car, or the same carousel).
Radio condition measurements, time measurements such as timing advance, RSTD, and/or propagation delay.
RSRP, RSRQ, RSSI measured between a UE and the network.
Whether the UEs are transmitting on the same beam in case of multi-beam operations.
Whether the UEs are interested (or capable to provide) the same type of traffic/service/application.

The similarity s between measurements such as accelerometer can in one embodiment be measured by the Euclidian distance:

$$s = \sqrt{{\sum }_{i = 1}^{N} {\vert {x}_{1 , i} - {x}_{2 , i} \vert}^{2}}$$

where N is the number of measurements. x_{1,i} is i-th the measurement vector for UE 1, and x_{2,i} is the i-th measurement vector for UE 2, and |x_{1,i}−x_{2,i}| is the Euclidian distance between them. Then, the decision of whether to group a UE or not can be made by comparing to a similarity threshold β. If s<β, then UE 1 and 2 belongs to the same group. In another embodiment, in case multiple measurements is used, for example both accelerometer and gyroscope. The similarity can be calculated as,

$$s = \sqrt{{\sum }_{m = 1}^{M} {\sum }_{i = 1}^{N} {w}^{m} {\vert {x}_{1 , i}^{m} - {x}_{2 , i}^{m} \vert}^{2}}$$

m denotes the measurement index, e.g., m=1 corresponds to the accelerometer measurement, m=2 to the gyroscope etc. w^{m} is the normalization factor to account for the heterogeneity of the different measurement types, and can be calculated e.g., as the inverse of the Euclidian distance range (i.e., maximum-minimum) of the m-th measurement index. It can also be calculated as the inverse of the standard deviation for the m-th measurement index if such information is available.

In another embodiment, instead of the network, a UE elected/assigned as master node by the network, can also use the criteria described above to form a group for positioning purposes.

In another embodiment, a UE can decide itself to be the UE responsible for a group for positioning purposes in case it need its position in a more accurate way. How the UE forms a group can still be based on the various criteria described above.

In another embodiment, a master node can discover the UEs in proximity that are able to provide positioning information via the discovery procedure by e.g., advertising into the sidelink discovery message that the master node is interested in positing services. Only the UE who reply back to the master node and that are capable of performing positing-related measurements or procedures will be included in the group.

Additionally, during such discovery and capability exchange, a course range estimate could be obtained. Such range information can be used as additional input to the grouping, only grouping UEs in the proximity. The course ranging could be based on time measurements based on transmission and reception of communication messages and related signals, and potential message exchange with supporting information (for example, using MAC control element). Unlike for accurate ranging which in general requires exchange of dedicated wideband signals, course ranging would reuse the signals required for the communication that may very well be narrowband in its nature. Alternatively, course ranging can be obtained through pathloss and power measurements. For UEs equipped with multiple transmit and/or receive antenna elements, directional information could be part of the ranging.

In some embodiments, coarse ranging and filtering of UEs is first performed. Then fine ranging can be performed.

A MAC Control element can be defined such that each UE, when it receives a multicast signal, records the time stamp when the signal was received. Further, it also records the time stamp when the ACK is sent. The timing information about the received and transmitted signal can be provided to the master UE or network node using this control element.

A new logical channel ID (LCID) or extended logical channel ID (e-LCID) can be defined for this purpose.

For coarse ranging, one UE acts as a transmitter and the other UEs, which can listen to the transmitted signal and are intended to participate in the group, respond. For this a dedicated groupcast reference signal or message can be used. Alternatively, any positioning reference signal, uplink sounding reference signal (UL-SRS) for positioning or communication reference signals such as Channel Status Information Reference Signal (CSI-RS) can be used. The UEs which listens can record the timestamp when the message is received and respond with a timestamp when the ACK corresponding to the groupcast signal/message is transmitted. The format of response can be in a MAC control element payload.

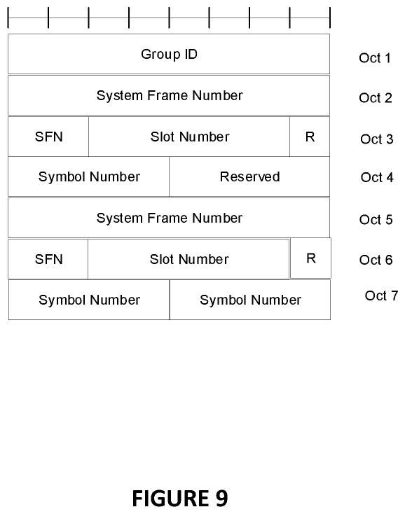

FIG. 9 illustrates an example MAC control element. The first octet represents the group ID of the receiver (UEs which listened to the signal from the transmitted. Next 3 octets represent the received signal reception time stamp whereas the bottom 3 octets represent the time stamp when the response (ACK) was sent.

The transmitter UE upon receiving this MAC CE can compute a coarse RTT. It records a time stamp when the transmission was performed and also when the ACK was received.

Depending upon the UE's group ID size the total size may vary. Further, the MAC header or one of the payload bits may also represent if angle-based measurements are included or not. The angle-based measurement may include angle representing 0 to 180/360 degrees for example in both azimuth and elevation directions.

### Grouping-Based Decisions

In some embodiment, the UEs may know that they are part of a group, or they can be unaware of this grouping from the network, or master node, side depending on the nature of the decisions. For example, if the group information is used as a statistic(s) for optimizing some network resources, such as more reliable handover procedure, or for example beam handling at the radio network node, then there is no reason for the UE to be aware of this grouping. In some other examples, in which one UE may have limited capability, it may request to obtain some group decisions from the network.

In terms of positioning estimation, as the sensor-based measurements may not be as reliable from some UEs, the network may require these measurements in combination with some other measurements, for example RSTD (Reference Signal Time Difference), to do some hybrid positioning. The aggregated measurements of all the UEs in the same group as the target device will provide a better set of data to make position estimation with less uncertainty. The positioning enhancements will be described below.

### Selecting Master UE/Group Leader

For efficient operations, it may be beneficial if one UE is chosen as master node for the group. The responsibilities of the master UE may be different in different scenarios. If the master UE is in-coverage, it can be responsible for setting up a connection with the network and to share ranging measurements, sensor data, etc. with the same. It can also be responsible for initiating group-based ranging procedures. In out-of-coverage, it may additionally serve as an absolute position reference.

In some embodiments, it may act as a positioning engine, calculating the position of other UEs, making use of collected measurements and data.

In some embodiments, the master node can provide some location server functionality, in lieu of the LMF, for sidelink positioning and/or ranging. It can have the capability to perform positioning and/or ranging calculations for other UEs.

The UE can be assigned as master node by the network, and such UE is preferably in-coverage. For out of coverage, the master may be chosen amongst the group members based on predefined criterions. The role could be restricted to dedicated devices with special capabilities, e.g. road side units (RSU) or a reference device with known position. Alternatively, the role could be assigned to the self-localization capable UE (e.g. with GNSS capability), with the highest positioning accuracy.

In some embodiments, multiple master nodes can be configured dynamically for example in the scenarios that range estimation cannot be estimated reliably for all UE in the group with a single master node (due to multipath fading or blockage, etc. in the sidelinks).

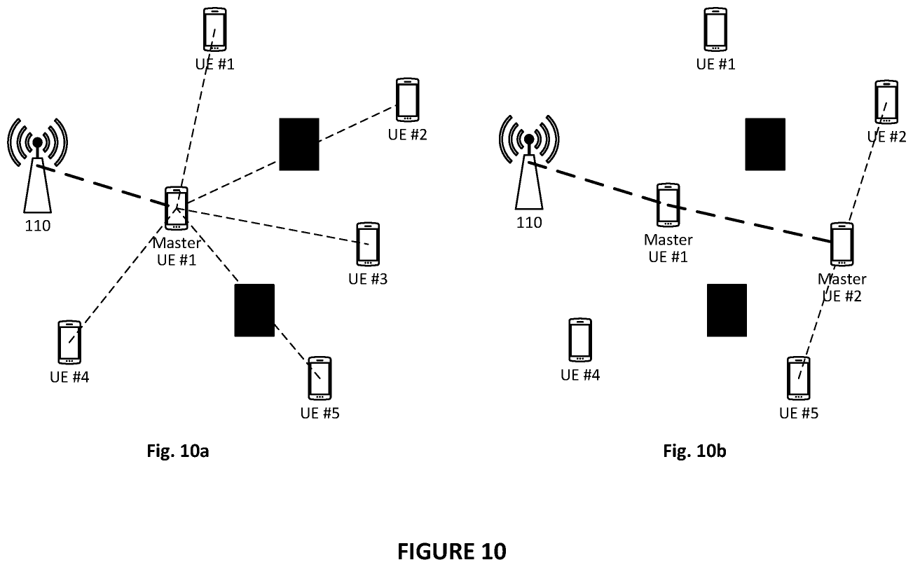

FIG. 10 illustrates two examples of blockage in the network. In the example of FIG. 10a, range estimation with Master UE #1 can be done for UEs 1, 3, 4, but not for UEs 2 and 5 due to blockage (the solid boxes). In the example of FIG. 10b, after the range estimation with master UE 1 is done, subsequently UE 3 (whose range/position is known now) can be configured as the master UE for range estimation to UEs 2 and 5. Alternatively, if the groupcast signal is also for all UEs with the Master UE #2, then range estimation (together with the error covariance) for UE 1, 3, 4 can be updated with the new measurements.

Ranging estimation in Groupcast Mode (Fine granular Reporting)

### Triggering of Group Based Ranging Procedure

An event for groupcast ranging can be initiated by the network through a request to the master UE. Upon reception of such request, the UE can start a procedure within the group.

In another embodiment, the master UE itself can identify a need and start a ranging procedure within the group.

In another embodiment, the master UE receives a request from a group member to initiate a ranging procedure within the group.

### Ranging Procedure

Once a group has been formed, and master(s) selected, a ranging procedure can be initiated as discussed above. The procedure can be based on a series of unicast ranging events (given that group member IDs are known apriori), or on one or multiple group-cast ranging events amongst group members, or a sub-set of positioning capable members only.

There are a number of known methods for performing ranging between two or more devices. A conventional RTT scheme involving time stamps of messages and exchange of processing times will be used for illustrative purposes.

One of the UEs (transmitter) in the group transmits a groupcast signal and timestamps the transmission. Once the signal is received by the other UEs in the group, each UE computes a sidelink-based UE Rx-Tx time difference. The Rx time is the time when the UE receives the groupcast signal. The Tx time can be pre-defined based upon a network configured time or can be defined as a fixed offset time (based upon the receiver UE Time) after receiving the groupcast signal (e.g. Tx after X symbols/slots from receiving the signal). This timing should be granular so that sidelink ranging can be precise.

Fine granular time measurements can be transmitted in a separate report message, where Rx-Tx time difference can be reported similarly as in ECID-SignalMeasurementInformation (3GPP TS 37.355 V16.6.0) for measurements between UE and gNB. Further, angle-based measurements may also be included as shown below.

-- ASN1START
SL-SignalMeasurementInformation ::= SEQUENCE {
sl-MeasuredResults MeasuredResultsElement OPTIONAL,

| | |
|---|---|
| sl-MeasuredResultsList | MeasuredResultsList, |

...
}
MeasuredResultsList ::= SEQUENCE (SIZE (1..32)) OF MeasuredResultsElement
MeasuredResultsElement ::= SEQUENCE {

| | | |
|---|---|---|
| sl-SystemFrameNumber | BIT STRING (SIZE (10)) | OPTIONAL, |
| sl-RSRP-Result | INTEGER (0..97) | OPTIONAL, |
| sl-RSRQ-Result | INTEGER (0..34) | OPTIONAL, |
| sl-UE-RxTxTimeDiff | INTEGER (0..4095) | OPTIONAL, |
| sl-Azimuth-r16 | INTEGER (0..359) | OPTIONAL, |
| sl-elevation | INTEGER (0..179) | OPTIONAL |

...
}
-- ASN1STOP

### Signaling Aspects

A positioning system information broadcast (posSIB) can be defined for sidelink-based ranging information provisioning to UEs such that the posSIB contains information such as range thresholds for the UEs to be allowed in a group. When the UEs are in-coverage they may read such information and when they are out of coverage they may still use it. Alternatively, such SIBs may be forwarded by the in-coverage UEs to the out-of-coverage UEs via one of the sidelink cast type (e.g. unicast, broadcast, groupcast). Such posSIB may be tagged with expiration timer and hence UEs would know for how long they can still use it. The posSIB can be used by the UEs to help create a meaningful group. The UEs can then perform the group-based positioning.

| | |
|---|---|
| posSIB-XY ::= | SEQUENCE { |
| rangingGroupThresholds | SEQUENCE { |
| velocityThreshold | INTEGER (0..511), OPTIOONAL |
| distanceThreshold | INTEGER (0..1000), OPTIOONAL |
| rsrp-Threshold | INTEGER (0..127), OPTIOONAL |
| rsrq-Threshold | INTEGER (0..127) OPTIOONAL |

```
    }
  }
```

For in-coverage groupcast based ranging, the UE capability can be signaled to the network node such as LMF. The LMF can take this groupcast-based capability into account. LMF can then identify UEs which can be formed into a group based upon measurements report received from several UEs. An example, if UEs report positioning from cell/beams and have uniform velocity, the LMF may initiate groupcast-based ranging for positioning estimation (e.g. relative positioning determination) and assign a master UE which can initiate a groupcast procedure.

An example of capability provisioning from a UE is shown below.

### ProvideCapabilities

The ProvideCapabilities message body in a LPP message indicates the LPP capabilities of the target device to the location server.

-- ASN1START
ProvideCapabilities ::= SEQUENCE {

| | |
|---|---|
| criticalExtensions | CHOICE { |
| c1 | CHOICE { |
| provideCapabilities-r9 | ProvideCapabilities-r9-IEs, |

```
      spare3 NULL, spare2 NULL, spare1 NULL
    },
    criticalExtensionsFuture SEQUENCE { }
  }
}
ProvideCapabilities-r9-IEs ::= SEQUENCE {
```

| | |
|---|---|
| commonIEsProvideCapabilities | CommonIEsProvideCapabilities |

OPTIONAL,

| | |
|---|---|
| a-gnss-ProvideCapabilities | A-GNSS-ProvideCapabilities |

OPTIONAL,

| | |
|---|---|
| otdoa-ProvideCapabilities | OTDOA-ProvideCapabilities |

OPTIONAL,

| | |
|---|---|
| ecid-ProvideCapabilities | ECID-ProvideCapabilities |

OPTIONAL,

| | |
|---|---|
| epdu-ProvideCapabilities | EPDU-Sequence |

```
  OPTIONAL,
  ...,
```

| | |
|---|---|
| [[ sensor-ProvideCapabilities-r13 | Sensor-ProvideCapabilities-r13 |

OPTIONAL,

| | |
|---|---|
| tbs-ProvideCapabilities-r13 | TBS-ProvideCapabilities-r13 |

OPTIONAL,

| | |
|---|---|
| wlan-ProvideCapabilities-r13 | WLAN-ProvideCapabilities-r13 |

OPTIONAL,

| | |
|---|---|
| bt-ProvideCapabilities-r13 | BT-ProvideCapabilities-r13 |

```
  OPTIONAL
  ]],
```

| | |
|---|---|
| [[ nr-ECID-ProvideCapabilities-r16 | NR-ECID-ProvideCapabilities-r16 |

```
  OPTIONAL,
    nr-Multi-RTT-ProvideCapabilities-r16
        NR-Multi-RTT-ProvideCapabilities-r16
  OPTIONAL,
    nr-DL-AoD-ProvideCapabilities-r16
        NR-DL-AoD-ProvideCapabilities-r16
  OPTIONAL,
    nr-DL-TDOA-ProvideCapabilities-r16
        NR-DL-TDOA-ProvideCapabilities-r16
  OPTIONAL,
```

| | |
|---|---|
| nr-UL-ProvideCapabilities-r16 | NR-UL-ProvideCapabilities-r16 |

```
  OPTIONAL
  ]],
  [[
  nr-SideLink-ProvideCapabilities-r17
        NR-Sidelink-ProvideCapabilities-r17OPTIONAL
  ]]
}
-- ASN1STOP
-- ASN1START
NR-Sidelink-ProvideCapabilities ::= SEQUENCE {
```

| | |
|---|---|
| groupCastRanging-r17 | ENUMERATED { supported } |

```
  OPTIONAL,
  ...
}
-- ASN1STOP
```

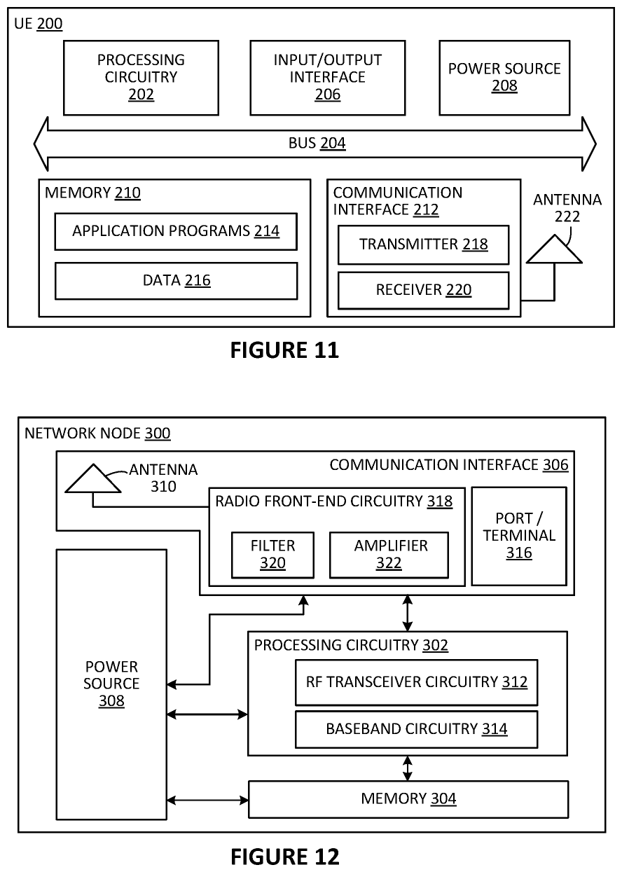

FIG. 11 shows a UE 200, which may be an embodiment of the UE 112 of FIG. 4 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 300, which may be an embodiment of the access node 110 or the core network node 108 of FIG. 4, in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 12 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

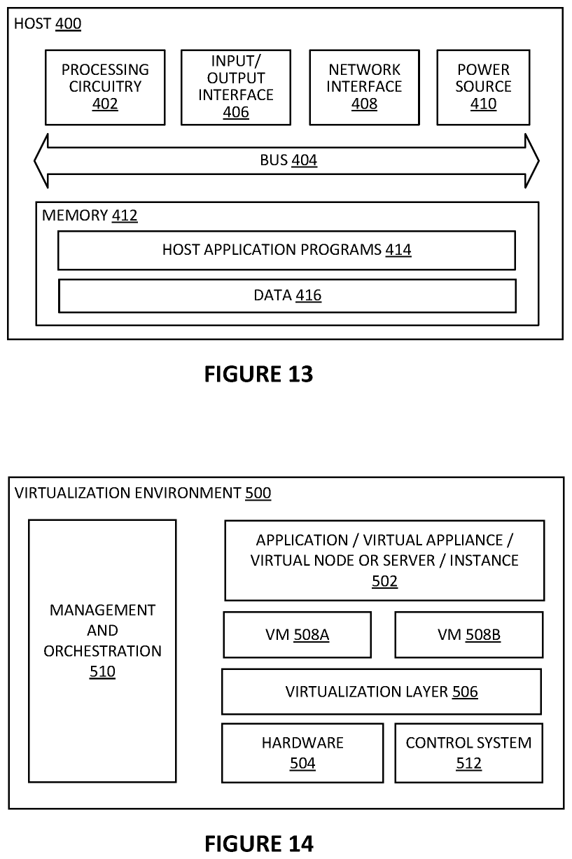

FIG. 13 is a block diagram of a host 400, which may be an embodiment of the host 116 of FIG. 4, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 8 and 9, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

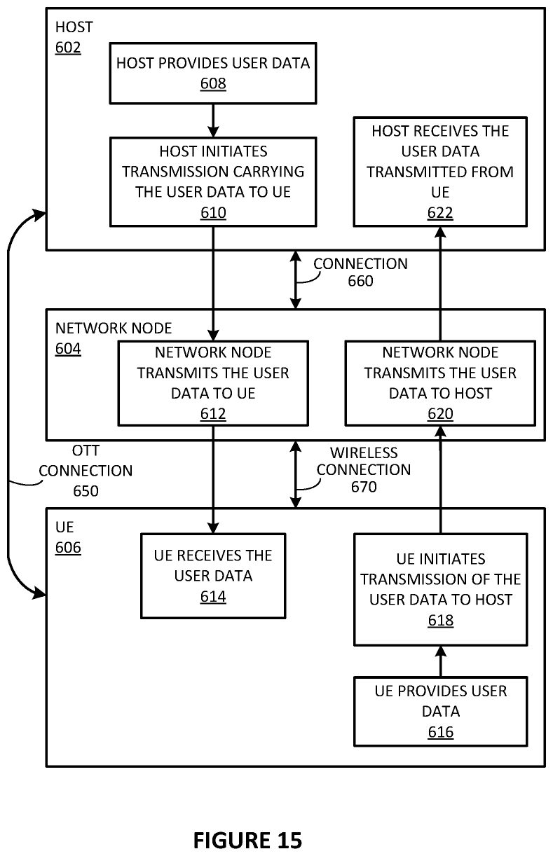

FIG. 15 shows a communication diagram of a host 602 communicating via a network node 604 with a UE 606 over a partially wireless connection in accordance with some embodiments. Example implementations, in accordance with various embodiments, of the UE (such as a UE 112A of FIG. 4 and/or UE 200 of FIG. 11), network node (such as network node 110A of FIG. 4 and/or network node 300 of FIG. 12), and host (such as host 116 of FIG. 4 and/or host 400 of FIG. 13) discussed in the preceding paragraphs will now be described with reference to FIG. 15.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the handling of colliding signals and/or channels and thereby provide benefits such as improving measurement latency and bypassing the measurement gap request procedure to improve positioning quality.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
6G 6^{th} Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1. A method performed by a first wireless device, the method comprising:
determining to initiate a sidelink group ranging procedure;
transmitting a ranging request to one or more second wireless devices;
receiving a ranging response, including timing information, from at least one of the second wireless devices; and
calculating a range for the at least one second wireless device in accordance with the timing information.

2. The method of claim 1, wherein the first wireless device determines to initiate a sidelink group ranging procedure in response to receiving a request for ranging measurements.

3. The method of claim 2, wherein the request for ranging measurements is received from one of: a network node or one of the second wireless devices.

4. The method of any one of claims 1 to 3, further comprising, receiving group membership information from a network node, wherein the group membership information identifies the one or more second wireless devices.

5. The method of claim 4, wherein the sidelink group ranging procedure is associated with the group membership information.

6. The method of any one of claims 1 to 5, further comprising, receiving an indication that the first wireless device is a master node for the sidelink group ranging procedure.

7. The method of claim 6, wherein the master node has a capability to perform at least one of positioning and ranging calculations for the second wireless devices.

8. The method of any one of claims 1 to 7, wherein the ranging request is transmitted via one of: unicast, multicast, and groupcast signaling.

9. The method of any one of claims 1 to 8, wherein the ranging request includes one of: a positioning reference signal (PRS), an uplink sounding reference signal (UL-SRS) for positioning, and a Channel Status Information Reference Signal (CSI-RS).

10. The method of any one of claims 1 to 9, wherein the ranging response includes a Medium Access Control (MAC) control element (CE) message.

11. The method of any one of claims 1 to 10, wherein the timing information includes at least one time measurement based on at least one of: reception of the ranging request and/or transmission of the ranging response by the at least one second wireless device.

12. The method of any one of claims 1 to 11, further comprising, determining a position of the at least one second wireless device in accordance with the timing information.

13. The method of claim 12, further comprising, transmitting, to a network node, the determined position of the at least one second wireless device.

14. The method of any one of claims 1 to 13, further comprising, transmitting, to a network node, the calculated range for the at least one second wireless device.

15. The method of any one of claims 1 to 14, further comprising, exchanging, with a network node, capability information associated with the sidelink group ranging procedure.

16. A first wireless device comprising a radio interface and processing circuitry configured to:
determine to initiate a sidelink group ranging procedure;
transmit a ranging request to one or more second wireless devices;
receive a ranging response, including timing information, from at least one of the second wireless devices; and
calculate a range for the at least one second wireless device in accordance with the timing information.

17. The first wireless device of claim 16, wherein the first wireless device determines to initiate a sidelink group ranging procedure in response to receiving a request for ranging measurements.

18. The first wireless device of claim 17, wherein the request for ranging measurements is received from one of: a network node or one of the second wireless devices.

19. The first wireless device of any one of claims 16 to 18, further configured to receive group membership information from a network node, wherein the group membership information identifies the one or more second wireless devices.

20. The first wireless device of claim 19, wherein the sidelink group ranging procedure is associated with the group membership information.

21. The first wireless device of any one of claims 16 to 20, further comprising, receiving an indication that the first wireless device is a master node for the sidelink group ranging procedure.

22. The first wireless device of claim 21, wherein the master node has a capability to perform at least one of positioning and ranging calculations for the second wireless devices.

23. The first wireless device of any one of claims 16 to 22, wherein the ranging request is transmitted via one of: unicast, multicast, and groupcast signaling.

24. The first wireless device of any one of claims 16 to 23, wherein the ranging request includes one of: a positioning reference signal (PRS), an uplink sounding reference signal (UL-SRS) for positioning, and a Channel Status Information Reference Signal (CSI-RS).

25. The first wireless device of any one of claims 16 to 24, wherein the ranging response includes a Medium Access Control (MAC) control element (CE) message.

26. The first wireless device of any one of claims 16 to 25, wherein the timing information includes at least one time measurement based on at least one of: reception of the ranging request and/or transmission of the ranging response by the at least one second wireless device.

27. The first wireless device of any one of claims 16 to 26, further configured to determine a position of the at least one second wireless device in accordance with the timing information.

28. The first wireless device of claim 27, further configured to transmit, to a network node, the determined position of the at least one second wireless device.

29. The first wireless device of any one of claims 16 to 28, further configured to transmit, to a network node, the calculated range for the at least one second wireless device.

30. The first wireless device of any one of claims 16 to 29, further configured to exchange, with a network node, capability information associated with the sidelink group ranging procedure.

31. A method performed by a network node, the method comprising:
transmitting, to a first wireless device, a request for ranging measurements for one or more second wireless devices; and
receiving, from the first wireless device, at least one ranging measurement for the one or more second wireless devices.

32. The method of claim 31, further comprising, exchanging, with the first and second wireless devices, capability information associated with the sidelink group ranging procedure.

33. The method of claim 32, further comprising, determining one or more groups of wireless devices in accordance with the received capability information.

34. The method of any one of claims 31 to 33, further comprising, determining one or more groups of wireless devices in accordance with the received ranging measurements.

35. The method of any one of claims 31 to 34, further comprising, transmitting group membership information to at least one of the first and second wireless devices.

36. The method of any one of claims 31 to 35, wherein the request for ranging measurements is a request to initiate a sidelink group ranging procedure.

37. The method of any one of claims 31 to 36, further comprising, transmitting an indication that the first wireless device is a master node for the sidelink group ranging procedure.

38. The method of claim 37, wherein the master node has a capability to perform at least one of positioning and ranging calculations for the second wireless devices.

39. The method of any one of claims 31 to 38, wherein the received ranging measurement includes at least one calculated range for at least one of the second wireless devices.

40. The method of any one of claims 31 to 39, wherein the received ranging measurement includes at least one time measurement based on reception of the ranging request and/or transmission of the ranging response by the at least one second wireless device.

41. The method of any one of claims 31 to 40, further comprising, receiving, from the first wireless device, a position of at least one of the second wireless devices.

42. A network node comprising a radio interface and processing circuitry configured to:
transmit, to a first wireless device, a request for ranging measurements for one or more second wireless devices; and
receive, from the first wireless device, at least one ranging measurement for the one or more second wireless devices.

43. The network node of claim 42, further configured to exchange, with the first and second wireless devices, capability information associated with the sidelink group ranging procedure.

44. The network node of claim 43, further configured to determine one or more groups of wireless devices in accordance with the received capability information.

45. The network node of any one of claims 42 to 44, further configured to determine one or more groups of wireless devices in accordance with the received ranging measurements.

46. The network node of any one of claims 42 to 45, further configured to transmit group membership information to at least one of the first and second wireless devices.

47. The network node of any one of claims 42 to 46, wherein the request for ranging measurements is a request to initiate a sidelink group ranging procedure.

48. The network node of any one of claims 42 to 47, further configured to transmit an indication that the first wireless device is a master node for the sidelink group ranging procedure.

49. The network node of claim 48, wherein the master node has a capability to perform at least one of positioning and ranging calculations for the second wireless devices.

50. The network node of any one of claims 42 to 49, wherein the received ranging measurement includes at least one calculated range for at least one of the second wireless devices.

51. The network node of any one of claims 42 to 50, wherein the received ranging measurement includes at least one time measurement based on reception of the ranging request and/or transmission of the ranging response by the at least one second wireless device.

52. The network node of any one of claims 42 to 51, further configured to receive, from the first wireless device, a position of at least one of the second wireless devices.
